(19) United States
(12) Patent Application Publication
(10) Pub. No.: US 2015/0220471 A1
(43) Pub. Date: Aug. 6, 2015

(54) COMMUNICATION SYSTEM

(71) Applicant: DENSO CORPORATION, Kariya-city (JP)

(72) Inventors: Kenji INAZU, Toyota-city (JP); Shinichirou TAGUCHI, Nagoya-city (JP); Hirofumi YAMAMOTO, Obu-city (JP); Keita HAYAKAWA, Nagoya-city (JP); Hironobu AKITA, Okazaki-city (JP); Shigeki OHTSUKA, Kariya-city (JP); Nobuaki MATSUDAIRA, Kariya-city (JP); Takahisa YOSHIMOTO, Kariya-city (JP)

(21) Appl. No.: 14/606,336

(22) Filed: Jan. 27, 2015

(30) Foreign Application Priority Data
Feb. 5, 2014 (JP) 2014-20228

(51) Int. Cl. G06F 13/40; G06F 13/42

(52) U.S. Cl. CPC G06F 13/4068; G06F 13/4221

(57) ABSTRACT

A communication system includes a communication wiring, at least one master node connected to the communication wiring, and at least one slave node connected to the communication wiring. The at least one master node and the at least one slave node are connected in a ring shape through the communication wiring and communicate in a start-stop synchronous communication.

### CROSS REFERENCE TO RELATED APPLICATION

This application is based on Japanese Patent Application No. 2014-20228 filed on Feb. 5, 2014, the disclosure of which is incorporated herein by reference.

### TECHNICAL FIELD

The present disclosure relates to a communication system in which one or more master nodes and one or more slave nodes are connected in a ring shape through a communication wiring. The communication system performs communication between the master nodes and the slave nodes.

### BACKGROUND ART

Non-patent literature 1: Serial WireRing-High-Speed Interchip Interface, Thorsten Huck, Andreas Rohatschek, Dieter Thoss, and Stoyan Todorov, Robert Bosh GmbH, SAE International, published Apr. 16, 2012.

In recent years, since information technology in automobile progresses, a vehicle may have more ECUs (electronic control units), sensors, and actuators. As a result, the amount of wiring harness increases. Signal lines between ECUs, between ECUs and sensors/actuators, or between sensors/actuators may be changed to a communication so that the amount of the wiring harness may be reduced. Currently, a communication protocol such as CAN (a registered trademark), LIN (a registered trademark), or the like is used to satisfy the above demand. However, communication speed of the protocols is equal to or less than 0.5 Mbps. The communication speed of the protocols is slow, and it may not be possible to meet a demand for high speed communication. Since a bus-type communication topology is used in the protocols, influence of parasitic capacity and reflection is large and a signal waveform may be deformed when the communication speed is high.

Wiring branching may be reduced or eliminated in order to minimize the influence of the parasitic capacity and the reflection. In order to perform high speed communication between multiple nodes, a topology that combines a one-to-one configuration may be required. For example, one of the communication modes may be a ring type being a circular topology, in which the multiple nodes are connected in a row (also referred to as in a daisy chain manner). Since an exchanger may be unnecessary in the ring type, it may be possible to reduce cost than a star type. In addition, since data returns to a transmission source, a reception confirmation may be easy.

As an example of the ring type topology, Serial WireRing has been known (referring to non-patent literature 1). In Serial WireRing, one master node and multiple slave nodes are connected in a circular shape. Since the multiple slave nodes perform CDR (Clock Data Recovery), a communication may be performed without a clock line.

The applicants of the present disclosure have found the following. Since Serial WireRing has to always synchronize using the CDR, a signal may always exist on a communication wiring and power consumption may increase.

### SUMMARY

It is an object of the present disclosure to provide a communication system that is configured at a reduced cost and communicates in low power consumption.

According to one aspect of the present disclosure, a communication system includes a communication wiring, at least one master node connected to the communication wiring, and at least one slave node connected to the communication wiring. The at least one master node and the at least one slave node are connected in a ring shape through the communication wiring and communicate in a start-stop synchronous communication.

According to the communication system, it may be possible to reduce cost of the communication system by using a ring shape network topology. It may be possible that each node performs communication in power saving by using a start-stop synchronous communication.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a drawing illustrating a configuration of a communication system in a first embodiment;

FIG. 2 is a drawing illustrating a case where the communication system is used in a vehicular camera;

FIG. 3 is a block diagram illustrating a configuration example of a communication node;

FIG. 4 is a drawing illustrating an example that a slave node receives a command and transmits a response in a normal communication;

FIG. 5 is a drawing illustrating the example of FIG. 4 that a slave node receives a command and transmits a response in a normal communication;

FIG. 6A is a drawing illustrating a configuration example of a command;

FIG. 6B is a drawing illustrating a configuration example of a command and a response;

FIG. 6C is a drawing illustrating a configuration example of a response;

FIG. 6D is a drawing illustrating a configuration example of a command with a preamble;

FIG. 7 is a flowchart of an operation in a slave;

FIG. 8 is a drawing illustrating an example that a slave receives a command and transmits a response when a failure occurs in a slave X during the normal operation;

FIG. 9 is a drawing illustrating a first operation example of a failure detection mode in an abnormal mode;

FIG. 10 is a drawing illustrating a second operation example of the failure detection mode in the abnormal mode;

FIG. 11 is a drawing illustrating an operation example in a failure bypass mode when a slave X is in failure;

FIG. 12 is a drawing illustrating the example of FIG. 11 in the failure bypass mode when the slave X is in failure;

FIG. 13 is a flowchart of an operation in a slave in a modification;

FIG. 14 is a sequence diagram illustrating a procedure of a reception confirmation performed between two nodes;

FIG. 15 is a drawing illustrating an operation example in a second embodiment;

FIG. 16A is a drawing illustrating a configuration in a third embodiment;

FIG. 16B is a drawing illustrating a communication in the third embodiment;

FIG. 17 is a sequence diagram illustrating a procedure of a communication between a master and a slave;

FIG. 18A is a drawing illustrating a configuration of a communication system in a forth embodiment;

FIG. 18B is a drawing illustrating a configuration of a communication system in the fourth embodiment;

FIG. 19 is a drawing illustrating a configuration of a communication system in the fourth embodiment; and

FIG. 20 is a sequence diagram illustrating a procedure of a communication between a node X and a node Y.

### DETAILED DESCRIPTION

### First Embodiment

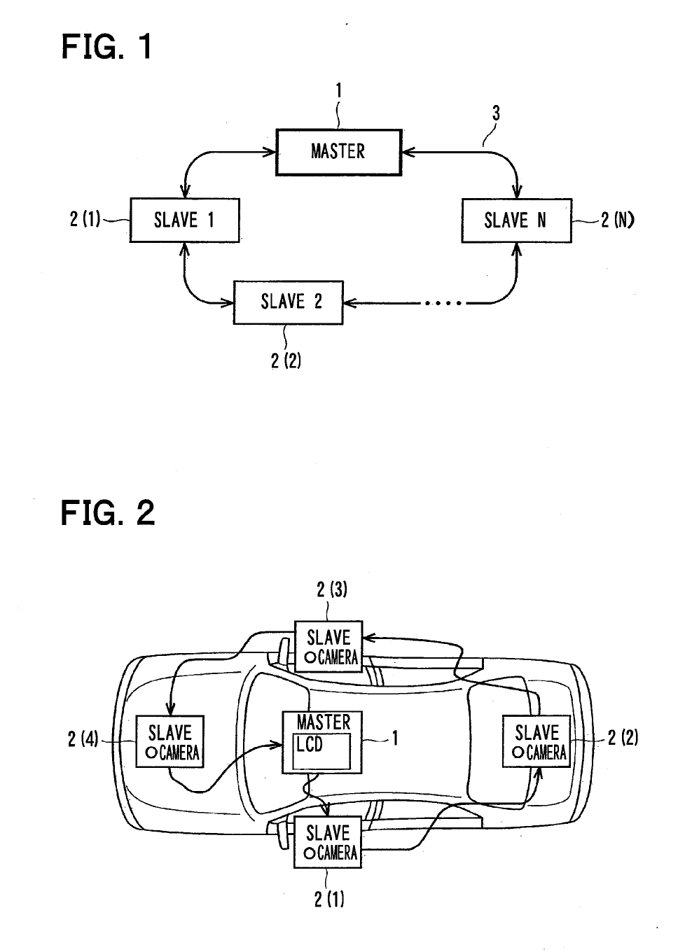

As described in FIG. 1, a communication system in the present disclosure includes, for example, one master node 1, multiple slave nodes 2 (1, 2, . . . , N), and a communication wiring 3. The master node 1 and the multiple slave nodes 2 (1, 2, . . . , N) are connected through the communication wiring 3 in a ring shape (a daisy chain connection). A specific example of the communication system in the present disclosure may correspond to a system in which multiple cameras (corresponding to the slave nodes) provided to a vehicle images an image around the vehicle, an image data of the image is transmitted with a vehicular LAN or the like, and a display (corresponding to the master node) such as LCD provided to the inside of a cabin displays the image as described in FIG. 2, for example.

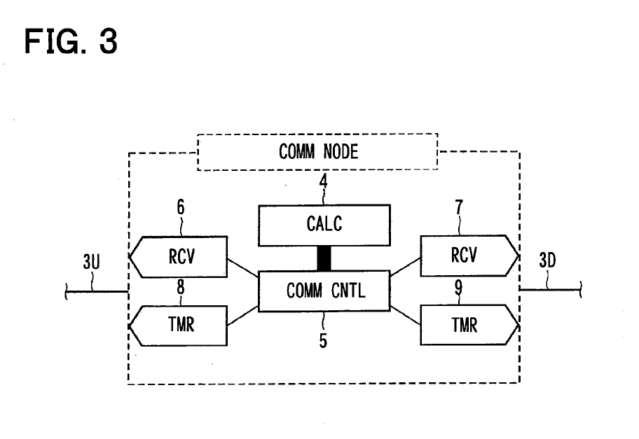

FIG. 3 describes a communication node and the communication wiring 3. One node has two sides of the communication wiring 3 indicated with symbols 3U, 3D. The communication node in FIG. 3 is common between the master node and the slave node. The communication node includes a calculation portion 4, a communication controller 5, receivers 6, 7, and transmitters 8, 9. The communication node enables to perform a bidirectional communication in a ring shape communication network. The receiver 6 and the transmitter 8 are connected to a side of the communication wiring 3U. The receiver 7 and the transmitter 9 are connected to a side of the communication wiring 3D. The calculation portion 4 is configured from a microcomputer, for example. The calculation portion 4 generates a command transmitted to slaves and transmits the command to the communication wiring 3 through the communication controller 5 when the node corresponds to the master node. The master receives a response transmitted from the slave corresponding to the command through the communication controller 5.

Incidentally, a slave node may be referred to as a slave, and a master node may be referred to as a master for simplicity.

The calculation portion 4 performs a calculation corresponding to the received command when the node corresponds to the slave. The node transmits a response through the communication controller 5 when the response is generated. The communication controller 5 does not transmit a command to the calculation portion 4 and processes the command in a case where the command does not require calculation by the calculation portion 4.

The receiver 6 receives data transmitted from another node positioned upstream of the node through the communication wiring 3U. The transmitter 8 transmits data to another node positioned upstream of the node through the communication wiring 3U. Similarly, the receiver 7 receives data transmitted from another node positioned downstream of the node through the communication wiring 3D. The transmitter 9 transmits data to another node positioned downstream of the node through the communication wiring 3D. The communication controller 5 switches data path through the receivers 6, 7 and the transmitters 8, 9.

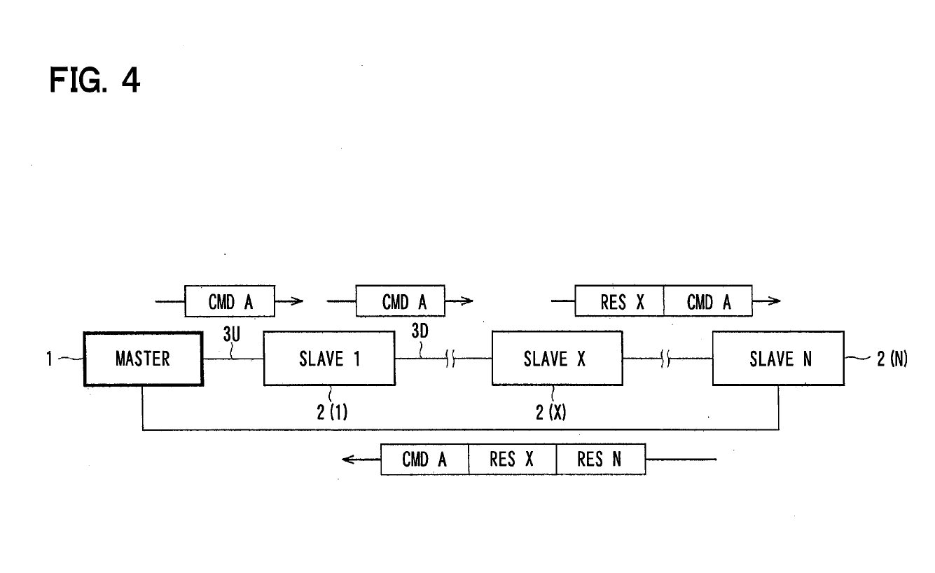

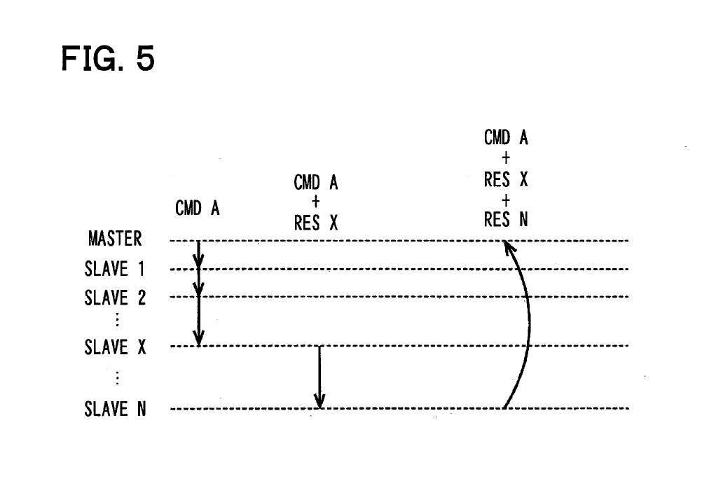

Effects of the present disclosure will be explained. A case where a normal communication is performed corresponds to a normal mode. In the normal mode, the master 1 transfers a command to one direction continuously as described in FIG. 4 and FIG. 5. FIG. 4 and FIG. 5 illustrate an example of an operation in the normal mode. FIG. 4 and FIG. 5 illustrate a case where a command A is transmitted from the master 1. The command A requests a response of a slave X and a slave N. For example, the master 1 transmits the command A to a direction of a slave 2(1). The command A requests a response of a slave 2(X, N). Incidentally, the slave 2(X) and the slave 2(N) are included in the multiple slaves 2(1, 2, . . . , N). In this case, the slave 2(1) receives the command A by the receiver 6 of the slave 2(1), and just transmits the command A to the downstream through the transmitter 9 since it is determined that the command A is not designated to the slave 2(1).

When the slave 2(X) receives the command A, since the command A is designated to the slave 2(X), the slave 2(X) adds a response X to the command A and transmits the command A and the response X to the downstream. When the slave 2(N) receives the command A, since the command A is designated to the slave 2(N), the slave 2(N) further adds a response N to the command A, which has been added with the response X, and transmits the communication frame to the master 1 positioned downstream of the slave 2(N). The master 1 receives the command A, which has been added with the responses N, X. The master 1 transmits a next command when the master 1 confirms a reception of the responses N, X properly.

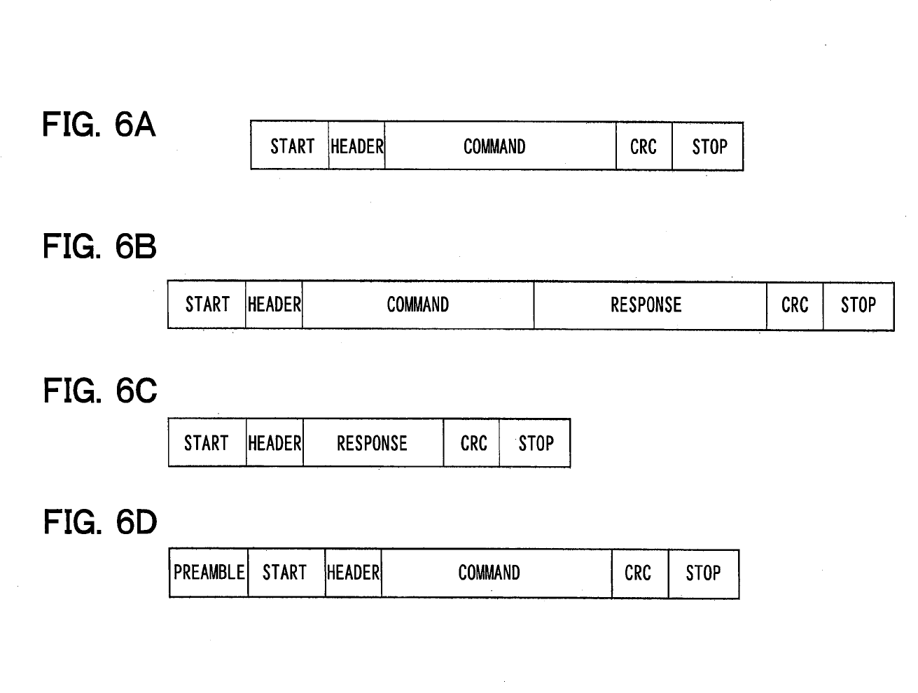

A communication frame transmitted in this case is in a start-stop synchronous communication method (also referred to as an asynchronous communication method). For example, as described in FIG. 6A, the communication frame is configured from a start pattern (also referred to as a start bit), a header, a command, a CRC (a cyclic redundancy check), and a stop pattern (also referred to as a stop bit). FIG. 6A illustrates an example of the command.

Incidentally, the start pattern represents a bit string indicating a start of a communication frame. A receiving node synchronizes communication using the start pattern (corresponding to a preamble).

The header represents a bit string indicating that the communication frame corresponds to either of a command and a response.

The command represents a bit string indicating a command. An address of a destination slave is also included in the command.

The CRC represents a cyclic redundancy check and corresponds to an error detection code.

The stop pattern represents a bit string indicating a termination of the communication frame.

Incidentally, in order to perform bit synchronization, a preamble (0 1 0 1 0 1 . . . ) repeating data values 0, 1 may be separately provided before the start pattern (FIG. 6D).

Incidentally, when the slave 2 returns a response, there are two cases. In one case, the response is inserted after the command as described in FIG. 6B. FIG. 6B illustrates an example of the command and the response. In the other case, the command is deleted and only the response is returned as described in FIG. 6C. FIG. 6C illustrates an example that only the response is provided between a pair of the start pattern and the stop pattern. Incidentally, in the former case, the header is changed and represents the command and the response.

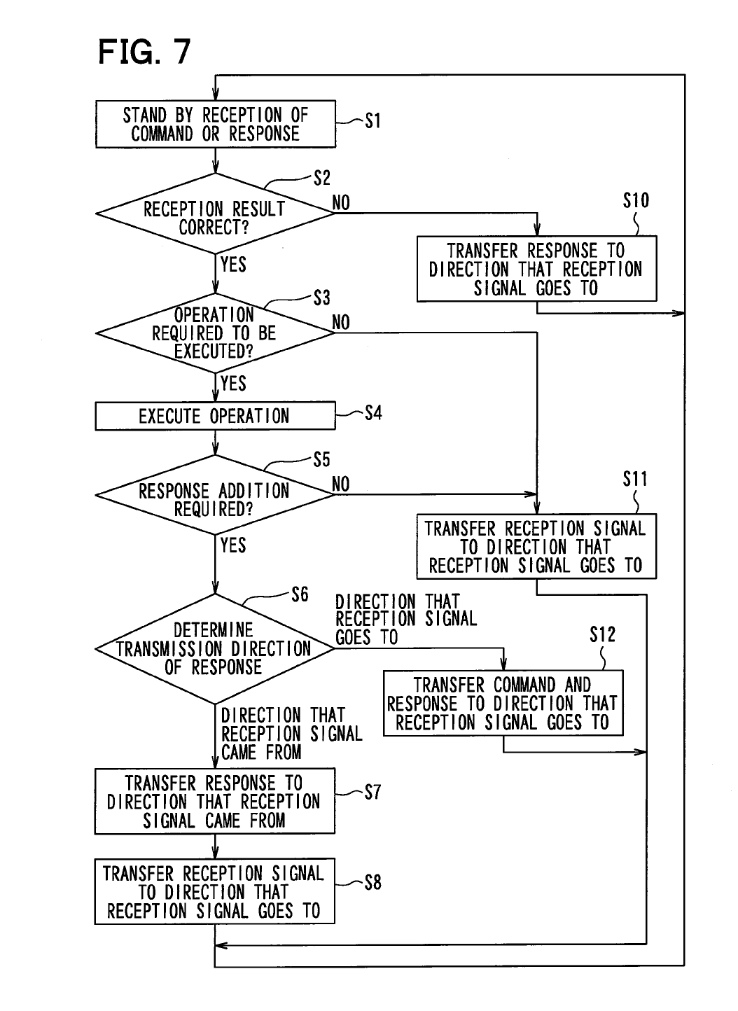

FIG. 7 illustrates an operation flowchart in a slave. The slave 2 stands by until the slave 2 receives the command or the response as described in FIG. 7 (S1). When the slave 2 receives the command, the slave 2 determines whether a reception result is correct based on the CRC (S2). When the reception result is correct (S2:YES), it is determined whether there is an operation to be executed based on the command (S3). When the reception result is not correct (S2:NO), the slave 2 transmits a response to the master 1 to a direction to which the receiving signal goes (S10), the response indicating that the slave 2 does not receive the command correctly.

In S3, when the slave 2 itself should execute an operation of the command (YES), the slave 2 executes contents of the command (S4). When it is not necessary to execute the operation of the command (S3:NO), the slave 2 transmits the reception signal (a command or a response) to a direction (corresponding to a direction of the downstream of the slave 2) to which the reception signal goes (S11). In S3, it is also checked whether the reception signal contains an error flag. When the error flag is contained, the reception signal (the command or the response) is transmitted to the direction (corresponding to a node positioned to downstream of the slave) to which the receiving signal goes (S11).

After executing S4, it is determined whether the slave 2 should add a response to the communication frame (S5). When it is required to add the response (YES), a direction to which the response is transmitted is determined according to contents of the reception signal (S6). In a case when the direction of the response corresponds to a direction from which the reception signal comes, the responds is transmitted to the direction from which the reception signal comes (S7) and the reception signal itself is transmitted to a direction to which the reception signal goes (S8). On the other hand, in a case when the direction to which the response is transmitted is the same direction as the direction to which the reception signal goes (S6), both of the command and the response are transmitted to the same direction (S12). Subsequently, the processing moves to S1.

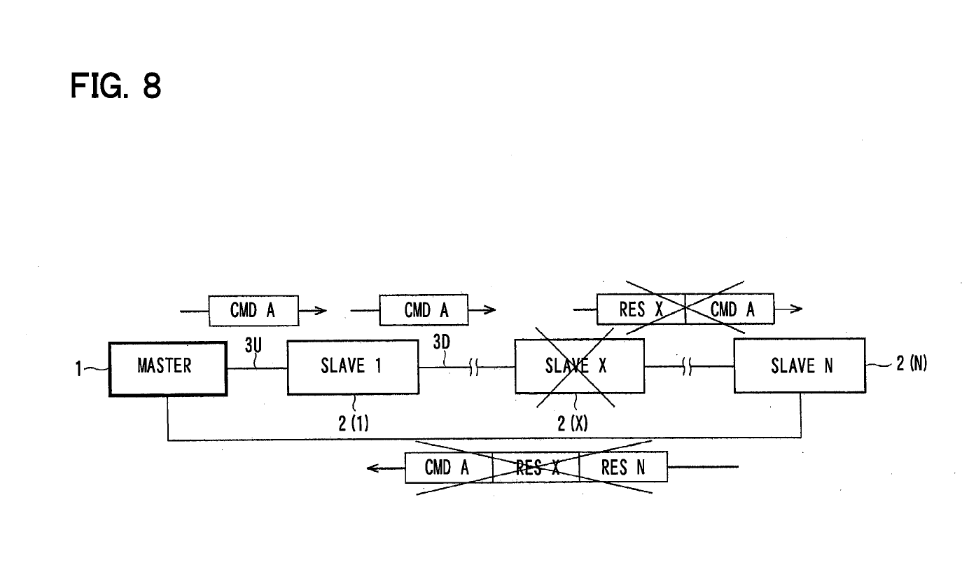

FIG. 8 illustrates an example of the failure detection and specifically, illustrates an example when the slave X has been failed in the normal mode.

When the normal communication in FIG. 4 is performed, it is assumed that, for example, a failure occurs in the slave 2(X). In this case, as described in FIG. 8, the communication frame including a command that the master 1 has transmitted is stopped at the slave 2(X) and a response is not transmitted to the master 1. The master 1 times out since the master 1 does not receive the response to a transmission of the command within a predetermined time. Thus, the master 1 determines that a failure occurs in either of the slaves 2.

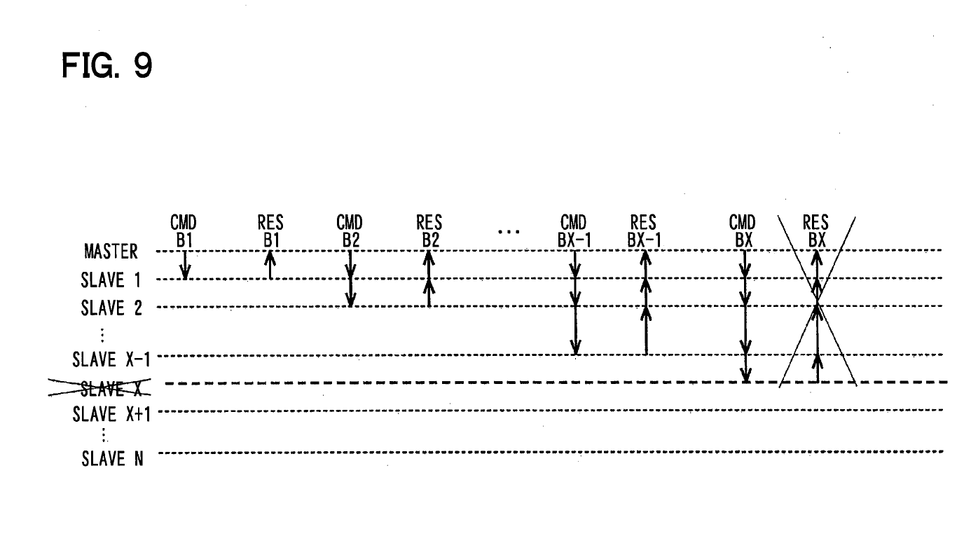

Since a time-out is occurred in communication error similarly, the master 1 determines this case as the communication error and transmits the same signal again when the number of times of the time-out is small. When the number of times of the time-out exceeds a predetermined value, the master 1 shifts a communication mode to a failure detection mode, which is one of abnormal modes. In the abnormal mode, a communication is performed for a purpose other than the normal communication. The abnormal mode corresponds to a communication mode other than the normal mode, and therefore may be referred to as a non-normal mode. The master 1 starts a failure position diagnosis with respect to the slave 2. In the failure position diagnosis, the master 1 separately designates the slaves 2(1 to N) and transmits a failure detection command B(1 to N), which causes to return a response. The failure detection command B may be referred to as a command B. FIG. 9 illustrates an example of the failure position diagnosis, and FIG. 9 illustrates a case where the slave X has been failed. For example, a command B1 corresponds to a command that causes the slave 2(1) to return a response (1). A command B2 corresponds to a command that causes the slave 2(2) to return a response (2). In this case, a direction to which the slave 2 returns the response corresponds to a direction from which the command (a receiving signal) comes (S7). The direction from which the command comes corresponds to an upstream direction for the slave 2. Incidentally, one slave 2 that has received a command B designated to the one slave 2 itself does not transmit the communication frame including the command B to the downstream of the one slave 2 (with referring to a transmission of commands in FIG. 9).

The master 1 transmits the commands B in series. When the master transmits a command BX, the master 1 does not receive a response X for a transmission of the command BX and times out. Therefore, the master 1 specifies a failure occurs in the slave 2(X). Strictly, it is considered that a failure may occur in the slave 2(X) or that a part of a communication wiring 3 between a slave 2(X−1) and the slave 2(X) may be disconnected or the like. Thus, the master 1 transmits the commands B from the opposite direction in series or transmits the command BX from the opposite direction. When the master 1 does not receive the response X, it is determined that the failure occurs in the slave 2(X). When the response X is returned, it is determined that a failure occurs in the communication wiring 3. That is, it may be possible to separate the failure into a failure in the slave BX and a failure in the communication wiring 3.

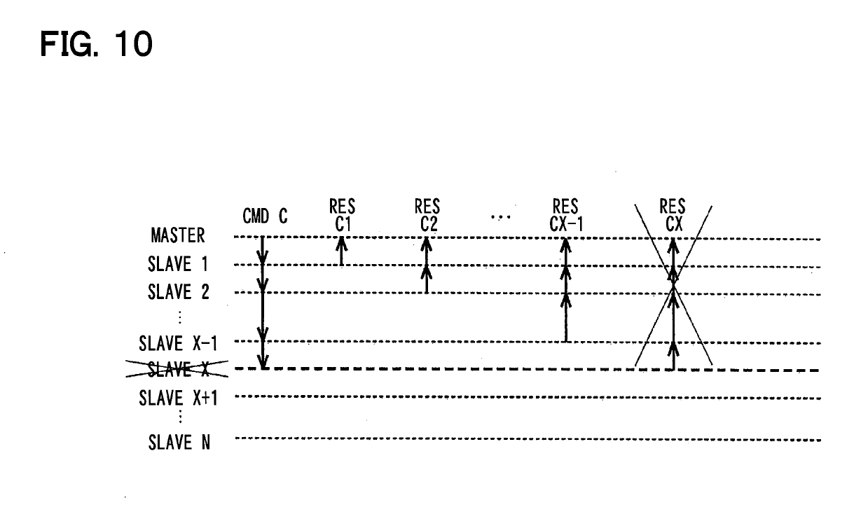

FIG. 10 illustrates a second example of the failure position diagnosis. A failure detection command C may be used in the failure position diagnosis as described in FIG. 10. The failure detection command C may be referred to as a command C. FIG. 10 illustrates a case where the slave X has been failed. The command C corresponds to a command that causes each of the slaves 2 receiving the command C to return a response. That is, the slave 2(1) transmits the command C to the next slave 2(2) and returns a response 2(1) to the master 1 when the slave 2(1) receives the command C. Similarly, the slave 2(2) transmits the command C to the next slave 2(3) and returns a response 2(2) to the master 1 through the slave 2(1) when the slave 2(2) receives the command C. Therefore, using the command C, it may be possible that a processing load on the master 1 is reduced.

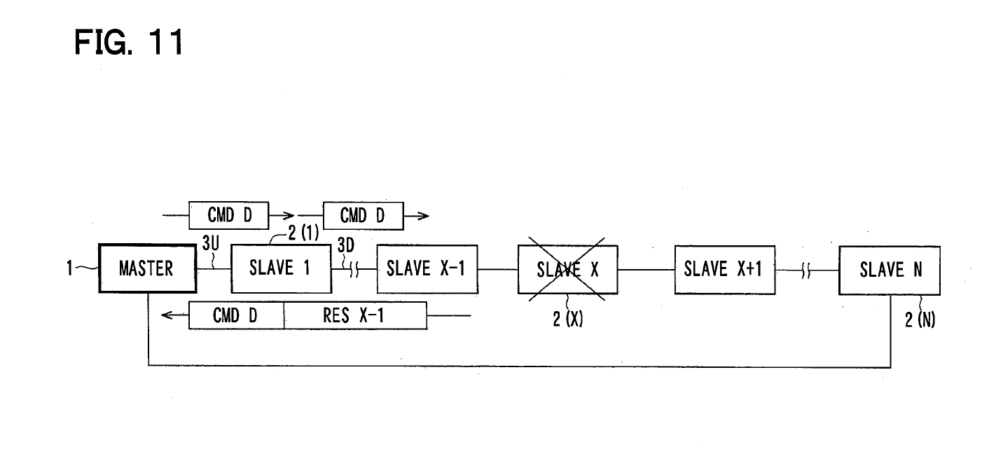

When the master 1 specifies a failure position in the slave 2, the master 1 shifts the communication mode to a failure bypass mode, so that the master 1 communicates with other slaves 2 by bypassing the slave 2(X). The failure bypass mode corresponds to one of the abnormal modes. FIG. 11 illustrates an operation example of a failure bypass mode when a slave node X has been failed. In FIG. 11, a node X has been failed and a slave X−1 returns a response. As described in FIG. 11, for example, when the master 1 requires a response of a slave 2(X−1), which is positioned just before the failed slave 2(X) from the master 1, the master 1 transmits a command D (a failure bypass command) in the failure bypass mode. Each node from the slave 2(1) to the slave 2(X−2) (not shown) transmits the command D to a downstream node.

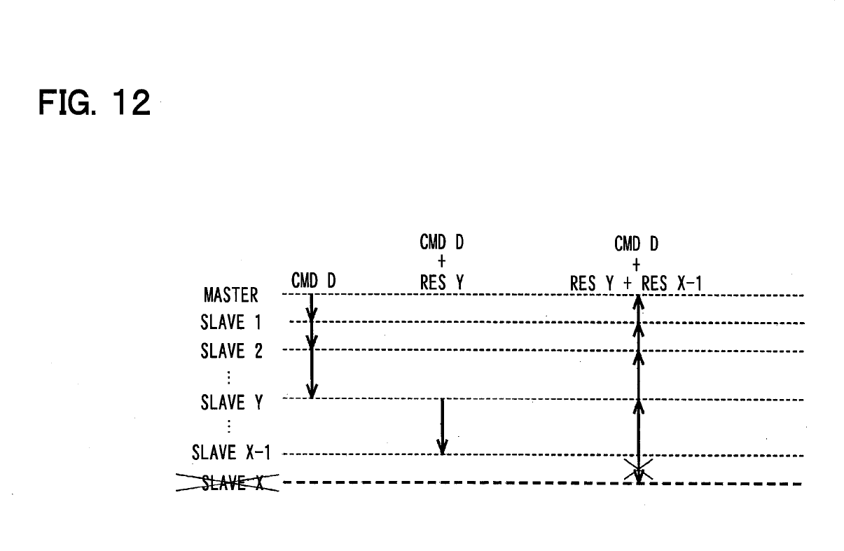

When the slave 2(X−1) receives the command D, the slave 2(X−1) adds a response (X−1) to the command D and returns to a slave 2(X−2). The slave 2(X−2) just transmits the reception signal to the upstream corresponding to the slave 2(X−3) without any change when the slave 2(X−2) receives the response (X−1). Each of the slaves 2 transmits the response (X−1) to the upstream side in series, and finally the master 1 receives the response (X−1) (referring to FIG. 11 and FIG. 12).

FIG. 12 illustrates an operation example of a failure bypass mode. FIG. 12 illustrates a case where a node X has been failed and slaves Y, X−1 returns responses Y, X−1.

When the master 1 requests a response of the slave 2(X+1), similar with a case when a cause of the failure is separated as described in FIG. 9, a command of the failure bypass mode is transmitted from the opposite direction so that the master 1 receives the response (X+1) from the slave 2(X+1). Accordingly, it may be possible that the master 1 obtains a response from all slaves 2 except for the slave 2(X), which has been failed.

According to the present disclosure, the master 1 and the multiple slaves 2 are connected in a ring shape through the communication wiring 3, and a communication is performed in the start-stop synchronous communication. Each node enables to receive and transmit data to the communication wiring 3 bidirectionally. A communication in the normal mode performed between the master 1 and the slaves 2 is performed in a single direction. Thus, it may be possible to configure a communication system at low cost by using a ring shape network topology. It may be possible that each node performs communication in power saving by using a start-stop synchronous communication. Since each of the nodes enables to perform a bidirectional communication, it may be possible to keep communication between the master 1 and the slave 2 by changing a communication direction when a failure occurs in either of the nodes, for example.

The master 1 transmits the command A in the normal mode. When the master 1 does not receive a response from a slave 2 corresponding to the command A within a predetermined time and the master 1 times out at least once or more, the master 1 initiates a communication for diagnosing a failure position and specifies a slave 2 in which a failure occurs. In this case, the master 1 in the failure detection mode transmits a failure detection command B causing to return a response in series. Initially, the failure detection command B is transmitted to a slave connected just adjacent to the master 1 initially, and then each of the slaves 2 is designated in series. Alternatively, the master 1 transmits the failure detection command C, which causes all slaves 2 to receive the command C in series and to return a response to the master 1 in series.

Each of the slaves 2 receives the command B or the command C addressed to itself, and then, each of the slaves 2 returns a response for the master 1 to a side of the communication wiring 3 from which the command B or the command C is received. The master 1 determines that a failure occurs in a slave 2 when the master 1 times out for a transmission of the command B or the command C for the first time. Accordingly, it may be possible that the master 1 specifies the slave 2 having the failure.

In addition, the master 1 switches from the failure detection mode to the failure bypass mode after specifying the slave 2 (a failure node) in which a failure occurs. In the failure bypass mode, the master 1 transmits a command used in the normal mode as a failure bypass command D. The master 1 transmits the command D in a first direction from the slave 2(1) to the slave 2(X−1) that is connected just before the failure node (the slave 2(X)). The master 1 transmits the command D in a second direction from the slave 2(X+1) to the slave (N). In this case, the master 1 is positioned between the slave 2(1) and the slave (N). A first direction is opposite to the second direction in the ring shape communication network. In other words, the master 1 transmits the command D in the first direction when the master 1 transmits the command D to the nodes positioned between the master 1 and the slave 2(X−1) without through the slave 2(X), and the master 1 transmits the command D in the second direction when the master 1 transmits the command D to the nodes positioned between the master 1 and the slave 2(X+1) without through the slave 2(X).

The slave 2 that has received the command D transmits a response for the command D to a side of the communication wiring 3 from which the slave 2 receives the command D. Accordingly, even when a failure occurs in either of the slaves 2 in a ring shape network topology, it may be possible to communicate with each of the slaves positioned on both sides of the failure node from either directions. Therefore, it may be possible to continue communication by bypassing the failure node.

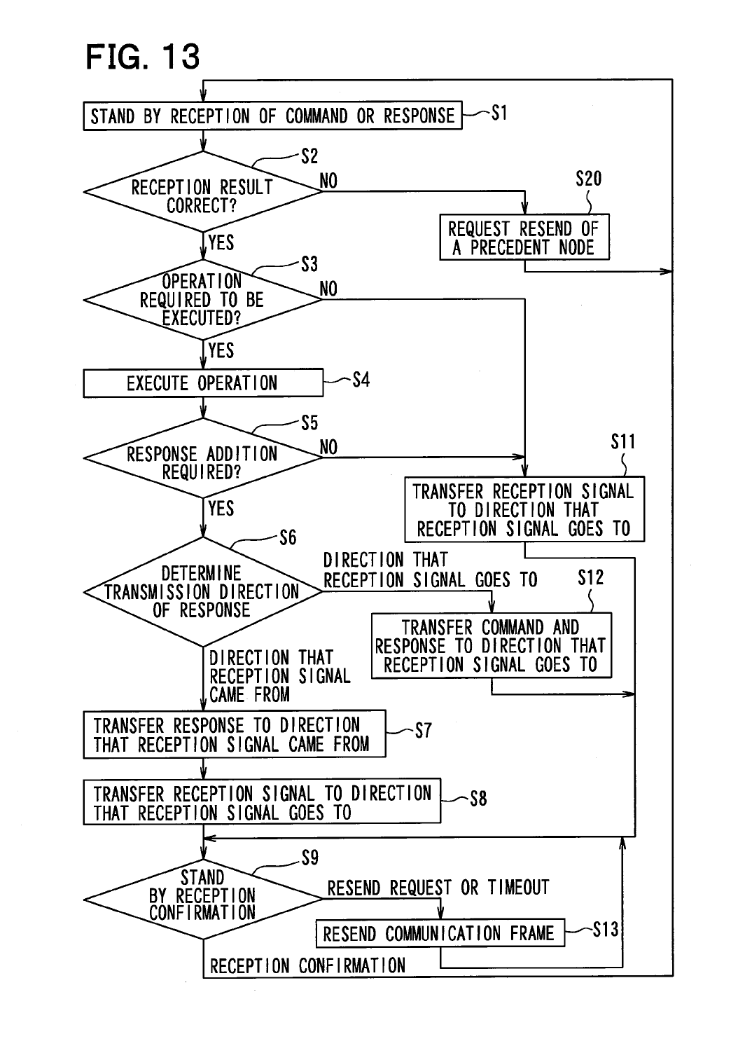

When failure detection such as the failure position diagnosis is performed in a system having many communication nodes, it may take long time before the master 1 times out and therefore, it may take long time to resend a command. In order to reduce a frequency that the master 1 times out, each node may perform a reception confirmation and a resending of a communication frame between each node. An example of an operation of the slave 2 in this case will be explained with referring to FIG. 13.

FIG. 13 illustrates an operation flowchart in a slave. The slave 2 requests a node preceding the slave 2 to resend a communication frame (S20) when the slave 2 determines NO at S2 as described in FIG. 13. The processing moves to S9 after S8, S11, and S12. The slave 2 stands by a reception of the reception confirmation. The processing returns to S1 when the slave 2 receives the reception confirmation. When the predetermined timeout time has been passed before the slave 2 receives the reception confirmation or when the slave receives a resending request from another node, the slave 2 resends the communication frame (S13) and the processing returns to S9.

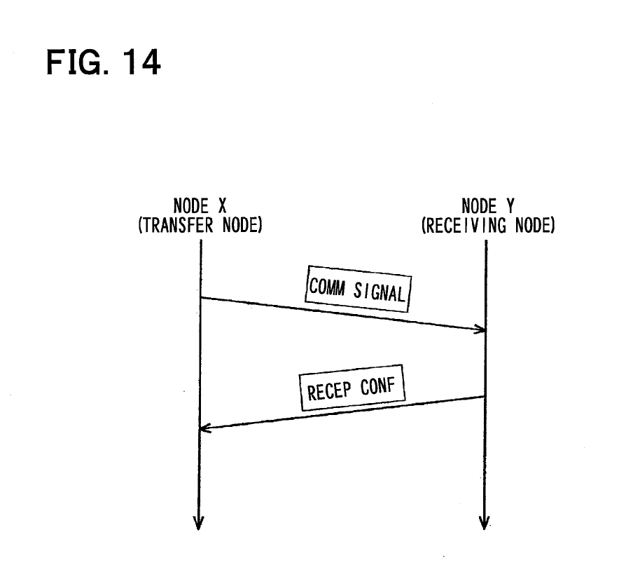

FIG. 14 illustrates an example of an operation of the reception confirmation. The processing of S9 will be explained with referring to FIG. 14. The node X corresponding to a transfer node transfers a communication signal (i.e., a command, a response, and the command and the response) to the node Y corresponding to a receiving node. The node Y checks the CRC as described above, and the node Y transfers a reception confirmation to the node X when there is no error in receiving contents. The node Y transfers a resend request to the node X when there is an error in receiving contents. The node X shifts to a standby state considering the communication signal has been transferred when the node X receives the reception confirmation.

The node X times out when the node X does not receive the reception confirmation within a predetermined time (corresponding to a timeout time Tout). The node X resends the communication signal to the node Y. In addition, the node X resends the communication signal when the node X receives a resend request. Incidentally, the timeout time Tout of the node X satisfies the following relationship:

Tout=T1×2+T2+T3;

T1 is equal to a delay time required for communication between the nodes X, Y;

T2 is a maximum time required for transferring a communication signal by the nodes X, Y; and

T3 is equal to a time required to confirm the node Y properly receives a signal and to transfer a reception confirmation.

In addition, due to resending the communication frame, the node Y may receive the same commands several times. Therefore, the command may be added with a value indicating the number of times of resending.

### Second Embodiment

Followingly, an explanation of the part identical with the first embodiment will be omitted and a part different from the first embodiment will be explained. In the second embodiment, the master 1 transfers a command E in a node number detection mode in order to determine the number of the slaves 2 when the master 1 does not know the number of the slaves 2 connected to the communication wiring 3 in advance. Incidentally, this manner is substantially similar to the failure position diagnosis described in FIG. 9. The node number detection mode corresponds to one of the abnormal mode.

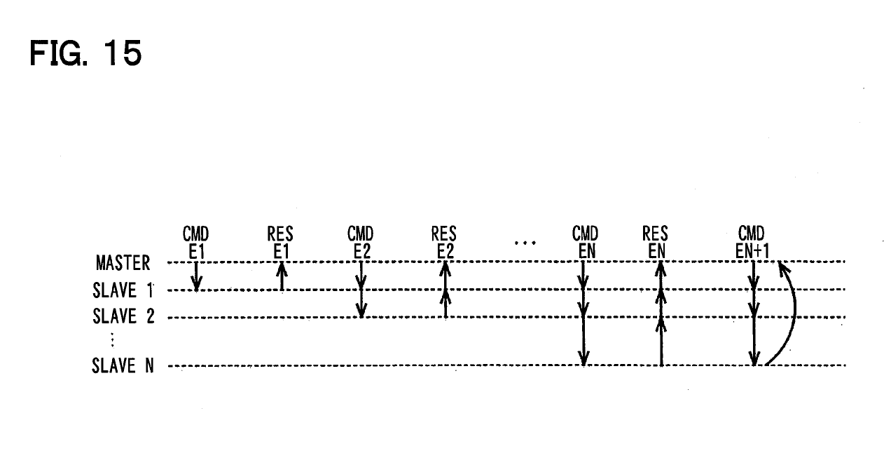

FIG. 15 illustrates an example of an operation that detects the number of the slaves. As described in FIG. 15, the master 1 separately designates each of the slaves 2(1 to N) and transfers the node number detection command E(1 to N) in order to cause to return a response. For example, the command E1 corresponds to a command that causes the slave 2(1) to return a response (1), and the command E2 corresponds to a command that causes the slave 2(2) to return a response (2).

It is assumed that the total number of the slaves 2 is equal to N. In this case, even when the master 1 transfers the command E(N+1), a slave 2 returning a response (N+1) does not exist. Thus, the master 1 receives the command E(N+1) that is not added with the response (N+1). Therefore, the master 1 determines that the number of the slaves 2 is equal to N when, for example, the master 1 counts the number of times of transmission of the command E. Incidentally, the number of the slaves 2 may be determined by using the command B or the command C.

According to the second embodiment, in the node number detection mode, the master 1 designates each of the slaves 2 and sends the command E that causes to return a response in series from the slave 2(1) just adjacently connected to the master 1. When the slave 2 receives the command E designated to the slave 2 itself, the slave 2 transfers a response to the master 1. When the master 1 receives a communication frame that is not added with a response to a transmission of the command E (that is, when the master 1 determines that the response has not been received), the master 1 determines the number of the slaves 2. Accordingly, it may be possible that the master 1 automatically determines the number of the slaves even when the number of the slaves 2 connected to the communication wiring 3 is unknown.

### Third Embodiment

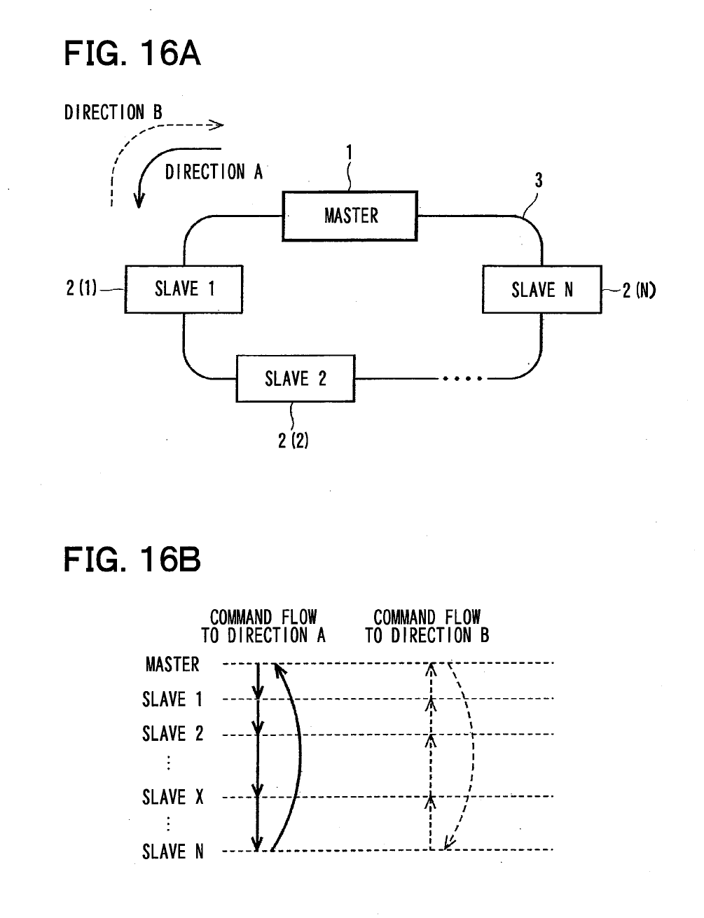

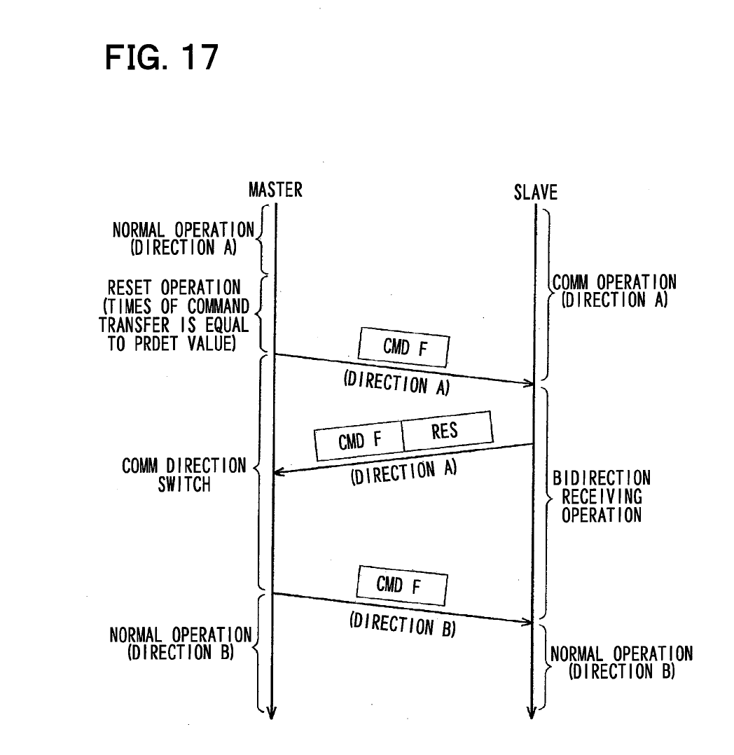

The master 1 switches communication directions (referring to directions A, B in FIG. 16A and FIG. 16B) on a network in the normal mode when a predetermined condition is satisfied. The predetermined condition corresponds to a case when, for example, power is turned on or the number of times of transmission of the command is equal to a predetermined value after a reset is released. The master 1 transfers a command to the slaves 2. FIG. 17 illustrates an operation of a communication direction shift. For example, as described in FIG. 17, when a current communication direction corresponds to a direction A, the master 1 stores information with respect to the communication direction in a nonvolatile memory (for example, a flash ROM, EEPROM, or the like). When, for example, a reset operation is performed, the master 1 transfers a command F to the slaves 2 in the communication direction A. The command F corresponds to a command for shifting the communication direction.

When each of the slaves 2 receive the command F, each of the slaves 2 adds a response and transfers the command F added with the response to another slave 2 positioned downstream of the slave 2. The slaves 2 that have received the command F stands by in a state where the slaves 2 enable to receive a command from either of the communication directions A, B (corresponding to a bidirectional receiving operation state). The master 1 transfers a command (for example, the command A) in the normal mode in the communication direction B when the master 1 receives the communication frame of the command F that has been added with responses of all slaves 2. When the slaves 2 receive the command in the communication direction B, the subsequent communication direction is fixed to the direction B.

Incidentally, the slaves 2 stand by in the bidirectional receiving operation state at the time when power is supplied or after a reset is released. According to a direction of the first command transferred from the master 1, the communication direction is fixed. The master 1 sets a timeout time T1 corresponding to a time from a transmission of the command F to a receiving of the communication frame of the command F added with responses by all slaves 2. The master 1 fixes the communication direction when the master 1 receives the communication frame within the timeout time T1. The master 1 resends the command F when the master 1 does not receive the communication frame within the timeout time T1.

The timeout time T1 is set at least longer than a time T2 corresponding to a time from when the master 1 transfers the command F to when the master 1 receives the communication frame. Therefore, the following relationship should be satisfied: T1>T2.

According to the third embodiment, the master 1 shifts the communication direction in the normal mode at timing when the predetermined condition is satisfied. For example, the master 1 stores a current communication direction in the normal mode. When the master 1 is turned on in the next time, the master 1 is reset, or the number of times of transmission of the command in the normal mode is counted and reaches to the predetermined value, the communication direction is changed. Accordingly, it may be possible that communication function in the master 1 and the slaves 2 evenly is used as much as possible so that a node life may be extended.

### Fourth Embodiment

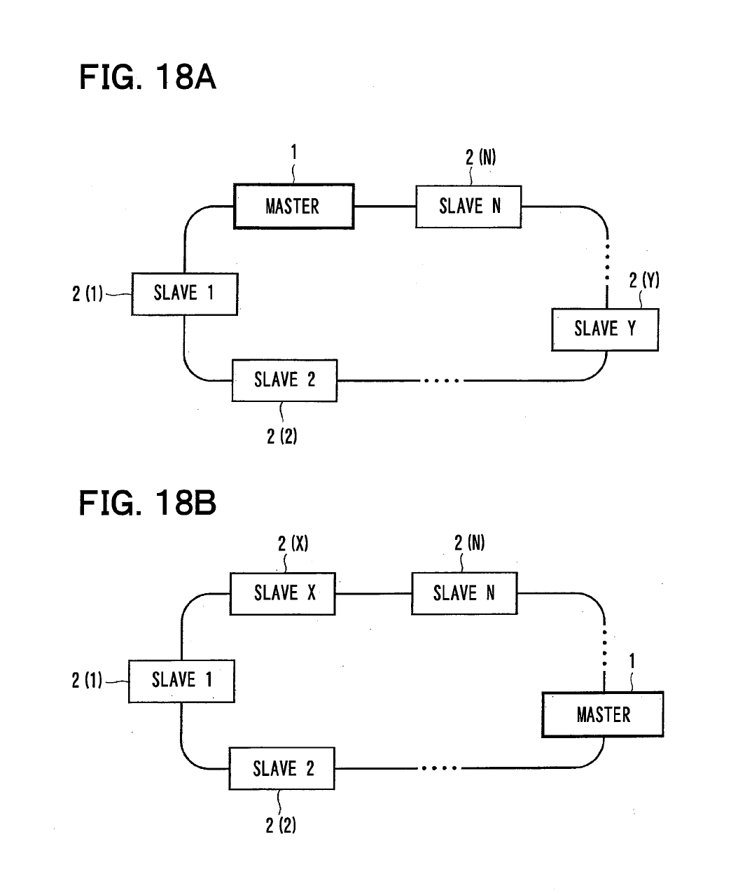

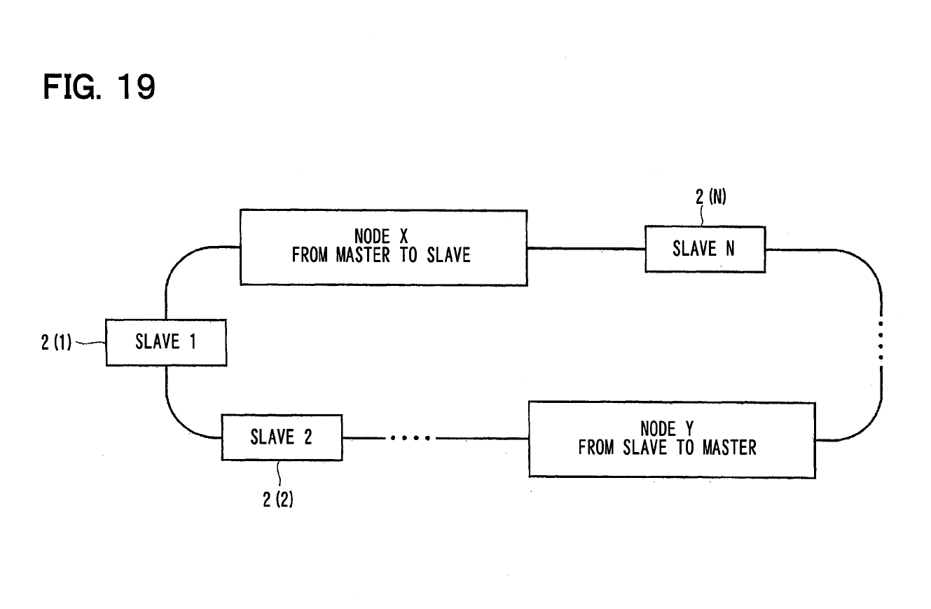

The fourth embodiment illustrates a switchover between the master 1 and the slave 2 as described in FIG. 18A, FIG. 18B and FIG. 19. FIG. 18A and FIG. 18B illustrate an example of an operation of a switchover of a master node. For example, it is assumed that the node X corresponds to the master 1 and the node Y corresponds to the slave 2(Y). In this case, the node X having a master authority transfers the master authority to the node Y. As a result, the node Y is changed to a master Y and the node X is changed to a slave 2(X). Incidentally, the nodes X, Y have software and hardware that enable to perform a function as a master and a function as a slave in advance.

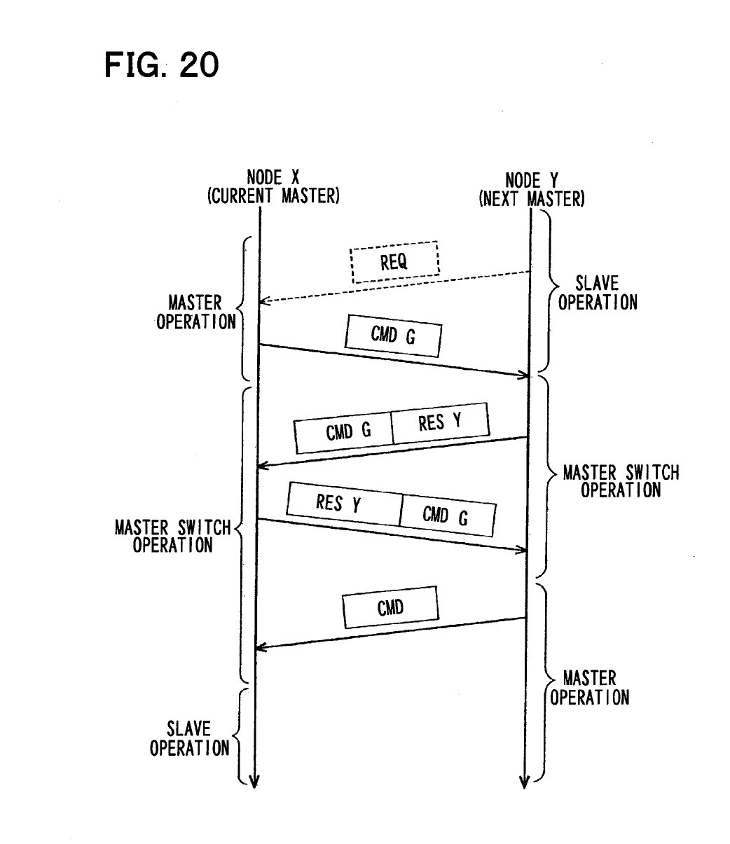

FIG. 20 illustrates an example of a sequence when a master is switched over. As described in FIG. 20, in one case, the node Y initially transfers a request of the master authority to the node X, which is a current master 1, and the node X transfers the master authority to the node Y. In another case, the node X transfers the master authority to the node Y without the request from the node Y. The request for the master authority from the node Y is transferred to another slave 2 positioned downstream of the node Y and transferred to the master 1 when communication is not performed, for example.

The node X transfers a master shift command G designating the node Y as a master. When the node Y receives the command G, the node Y adds a response Y (indicating a reception confirmation of the command G and a master shift acceptance of the node Y) to the command G and transfers the command G and the response Y to the node X. When the node X receives the communication frame of the command G added with the response Y, the node X just transfers to a side of the slave 2(1). When the node Y receives the communication frame of the command G with the response Y added by itself after the communication frame of the command G goes around the network, the node Y shifts a function to a function of the master.

The node Y sets a timeout time before the node Y receives the communication frame of the command G. The node Y continues to function as a slave when the node Y times out by exceeding the timeout time, or when the node Y receives a communication frame having another command. Since the communication frame including the response Y goes around the network, it may be possible that slaves 2 other than the nodes X, Y are informed a shift of the master.

The node X functions as a slave when the node Y operates as the master and the node X receive a command transferred from the node Y. In this case, a timeout time T3 corresponding to a time before the node X receives the command from the node Y is set. The node X determines that the node Y does not function as the master when the node X times out by exceeding the timeout time T3. The node X continues to function as the master. The timeout time T3 is set larger than the sum of a maximum time T4 and a maximum communication delay time T5 between the node Y and the node X. The maximum time T4 corresponds to a time from when the node Y detects a failure of slaves as the master to when failure detection is initiated. Therefore, the following relationship will be satisfied: T3>T4+T5.

According to the fourth embodiment, the master node X designates a slave node Y and transfers the master shift command G for shifting the master authority to the slave node Y when the predetermined condition is satisfied. The function of the master node X is changed to a slave node, and the function of the slave node Y, which is designated by the command G, is changed to a master node when the slave node Y receives the command G. Therefore, it may be possible to respond to a case where a shift of a master is required according to kinds of application used in the communication system.

Incidentally, it should be noted that the present disclosure is not limited to the described embodiment or the drawings. The following modifications or expansions will be possible.

One communication system may include two or more master nodes.

A communication direction of the communication node is not limited to a bidirectional communication and may be a single direction.

According to one aspect of the communication system in the present disclosure, at least one master node and at least one slave node are connected in a ring shape through a communication wiring. Communication is performed in a start-stop synchronous communication between the master node and the slave node. Therefore, it may be possible to reduce cost of the communication system by using a ring shape network topology. It may be possible that each node performs communication in power saving by using a start-stop synchronous communication.

According to the communication system in the present disclosure, each node enables to receive and transfer data bidirectionally to the communication wiring. A communication between a master node and a slave node includes a normal mode and an abnormal mode, at least. The normal mode corresponds to a communication mode in a normal state. The abnormal mode corresponds to the communication mode performed for a purpose other than the normal communication. The communication in the normal mode is performed in a single direction. The communication in the abnormal mode may be performed bidirectionally. The abnormal mode includes a failure detection mode, a failure bypass mode, or the like. Accordingly, it may be possible to perform a bidirectional communication in the abnormal mode when a failure occurs in either of the nodes and it may be possible that the master node and the slave node continue communication.

In addition, according to the communication system in the present disclosure, the abnormal mode includes the failure detection mode, in which communication is made for checking whether the slave node functions properly. The master node initiates communication in the failure detection mode when the master node transfers a command in the normal mode and the master node times out once or more times without receiving a response or a command from the slave node within a predetermined time. In this case, since it may be considered that a failure occurs in either of the slave nodes, the master node initiates communication in the failure detection mode for specifying the slave node in which the failure occurs.

In addition, according to the communication system in the present disclosure, the master node transfers a failure detection command that causes each of the slave nodes to return a response, in the failure detection mode. Each of the slave nodes receives the failure detection command, and transfers a response or a command to the master node through the communication wiring through which the failure detection command is received. The master node determines that a failure occurs in a slave node causing time out once or more, the slave node corresponding to a slave node for the first time that does not send a response or a command to a transmission of the failure detection command. Accordingly, it may be possible that the master node specifies the slave node in which a failure occurs.

In addition, according to the communication system in the present disclosure, the master node shifts the communication mode to a failure bypass mode, which is one of the abnormal modes, when the master node specifies the slave node (a failure node) in which a failure occurs. In the failure bypass mode, the master node transfers a command used in the normal mode as a failure bypass command and transfers the failure bypass command in a first direction from the slave node in the first direction to a last slave node before the failure node. The master node transfers the failure bypass command in the second direction from the slave node in the second direction to a last slave node before the failure node. The slave node that has received the failure bypass command transfers a response or a command for the failure bypass command to a side of the communication wiring from which the failure bypass command is received.

Accordingly, even when a failure occurs in either of the slave nodes in a ring shape network topology, it may be possible that the master node communicates with the slave nodes positioned to the both sides of the failure node. Therefore, it may be possible to bypass the failure node and to continue the communication.

It is noted that a flowchart or a processing of the flowchart in the present application includes steps (also referred to as sections), each of which is represented, for example, as S1. Further, each step may be divided into several sub-sections, and several sections may be combined into a single section. Furthermore, each of the configured sections may be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A communication system comprising:
a communication wiring;
at least one master node connected to the communication wiring; and
at least one slave node connected to the communication wiring, wherein
the at least one master node and the at least one slave node are connected in a ring shape through the communication wiring and communicate in a start-stop synchronous communication.

2. The communication system according to claim 1, wherein
each of the at least one master node and the at least one slave node enables to receive and transfer data bidirectionally to the communication wiring,
a communication mode between the at least one master node and the at least one slave node includes a normal mode and an abnormal mode,
the normal mode is performed in a normal communication, and
the abnormal mode is performed in a case other than the normal communication, and
communication in the normal mode is performed in a single direction.

3. The communication system according to claim 2, wherein
a plurality of slave nodes are connected to a master node,
the abnormal mode includes a failure detection mode checking whether the plurality of slave nodes function properly, and
the master node initiates communication in the failure detection mode when the master node in the normal mode transfers a command and the master node times out at least once without receiving the command or a response from the slave nodes within a predetermined time.

4. The communication system according to claim 3, wherein
the master node in the failure detection mode transfers a failure detection command to each of the slave nodes,
the failure detection command causes each of the slave nodes to return the response,
each of the slave nodes transfers the command or the response to the master node through a side of the communication wiring from which the failure detection command is received when each of the slave nodes receives the failure detection command, and
the master node determines that a failure occurs in one of the slave nodes when the one of the slave nodes does not transfer the command or the response to the failure detection command for a first time and has caused a timeout of the master node at least once.

5. The communication system according to claim 4, wherein
the one of the slave nodes having the failure corresponds to a failure node,
the abnormal mode further includes a failure bypass mode,
the master node shifts from the failure detection mode to the failure bypass mode when the master node specifies the failure node,
the master node in the failure bypass mode transfers the command used in the normal mode as a failure bypass command,
the master node transfers the failure bypass command in a first direction to a last slave node of the slave nodes before the failure node in the first direction from the master node,
the master node transfers the failure bypass command in a second direction to an other last slave node of the slave nodes before the failure node in the second direction from the master node, and
each of the plurality of slave nodes other than the failure node that receive the failure bypass command transfers the command or the response to the failure bypass command through each side of the communication wiring from which the failure bypass command is transferred.

6. The communication system according to claim 2, wherein
a plurality of slave nodes are connected to one master node,
the abnormal mode includes a node number detection mode determining a total number of the slave nodes connected to the communication wiring,
the master node in the node number detection mode transfers a node number detection command to each of the slave nodes,
the node number detection command causes each of the slave nodes to return a response,
each of the slave nodes transfers the command or the response to the master node when each of the slave nodes receives the node number detection command, and
the master node determines the total number of the slave nodes when the master node determines that the master node has not received the response to the node number detection command.

7. The communication system according to claim 2, wherein
the master node switches a communication direction in the normal mode to a reversed direction when a predetermined condition is satisfied.

8. The communication system according to claim 7, wherein
the master node stores a current communication direction in the normal mode, and
the master node switches the communication direction when power turns on next.

9. The communication system according to claim 7, wherein
the master node stores a current communication direction in the normal mode, and
the master node switches the communication direction when the master node is reset.

10. The communication system according to claim 7, wherein
the master node counts a total number of times of transmission of the command in the normal mode, and
the master node switches the communication direction when the total number of times of the transmission reaches a predetermined number.

11. The communication system according to claim 2, wherein
the at least one master node designates the at least one slave node and transfers a master shift command to the at least one slave node, and a function of the at least one master node is changed to a function as a slave node when a predetermined condition is satisfied, and
a function of the at least one slave node, which is designated by the master shift command, is changed to a function as a master node when the at least one slave node receives the master shift command.
